(19) United States
(12) Patent Application Publication
(10) Pub. No.: US 2005/0161501 A1
(43) Pub. Date: Jul. 28, 2005

(54) Value document and device for processing value documents

(75) Inventors: Thomas Giering, Kirchseeon (DE); Ralf Hobmeier, Muenchen (DE); Norbert Holl, Germering (DE); Alfred Schmidt, Muenchen (DE); Dieter Stein, Holzkirchen (DE); Christian Voellmer, Muenchen (DE); Bernd Wunderer, Muenchen (DE)

Correspondence Address: ROTHWELL, FIGG, ERNST & MANBECK, P.C., 1425 K STREET, N.W., SUITE 800, WASHINGTON, DC, 20005, US

(73) Assignee: Giesecke & Devrient GmbH, Muenchen (DE)

(21) Appl. No.: 10/498,779

(22) PCT Filed: Dec. 19, 2002
(86) PCT No.: PCT/EP02/14605

(30) Foreign Application Priority Data
Dec. 21, 2001 (DE) 101 63 266.5

(51) Int. Cl. G06F 17/60

(52) U.S. Cl. 235/379; 340/5.8

(57) ABSTRACT

The invention relates to a sheet-shaped value document, such as a bank note. An authenticity feature which can be reliably verified by machine or by humans and which can moreover not be deceptively imitated by copying technology is realized by an electro-optical and/or acoustic display device integrated in the value document.

### CROSS-REFERENCE TO RELATED APPLICATION

This application is a National Phase of International Application Serial No. PCT/EP02/14605, filed Dec. 19, 2002.

### FIELD OF THE INVENTIONI

This invention relates to sheet-shaped value documents, such as bank notes, and an apparatus for processing such sheet-shaped value documents.

### DESCRIPTION OF THE BACKGROUND ART

Although the invention is not restricted to certain types of sheet-shaped value documents, the following description will deal by way of example with the special problems of bank notes. Bank notes are normally printed to permanently mark information particularly relevant for the circulation of the bank notes, such as nominal value and issuing central bank. As machine-readable security elements, bank notes usually have various feature substances, such as magnetic, electric, luminescent, e.g. fluorescent, substances contained in the paper or in the printing ink. To permit the authenticity of bank notes to be checked by humans without the use of machines, tactilely or visually verifiable authenticity features such as intaglio printed structures, watermarks or optically variable, e.g. holographic, elements are additionally integrated into the bank note.

With respect to this prior art, the problem of the present invention is to provide such sheet-shaped value documents with new authenticity features which can be verified particularly reliably by humans. The problem is further to provide an associated apparatus for processing such value documents.

This problem is solved by the value document according to the invention.

### SUMMARY OF THE INVENTION

The present invention is based on the idea of equipping value documents with an electro-optical and/or acoustic display device which can display an information content optically or acoustically. Said electro-optical or acoustic display devices, which will also be referred to for short in the following as the (optical) display or audio transmitter, can have singly or in combination e.g. a self-luminous optical display radiating in the visible, infrared and/or UV spectral range and/or a non-self-luminous optical display and/or a display made of electronic paper and/or an LCD and/or an LED and/or an electroacoustic audio transmitter and/or a reciprocal piezoelectric audio transmitter and/or a magnetostrictive audio transmitter. The optical display can have a two-dimensional display surface e.g. in the form of an LCD, or an approximately point-shaped light source, such as a single LED. Electronic paper can refer here in the known way for example to a flexible substrate with microcapsules embedded between electrodes and rotatable or displaceable in controlled fashion.

An advantage of such electro-optical and/or acoustic display devices is that they form an authenticity feature which can be simply verified by humans and moreover not deceptively imitated by copying technology. Furthermore, said display devices can preferably also be used as a machine-readable security, i.e. authenticity, feature. For example, an associated bank note processing machine can comprise a sensor device which, optionally upon excitation of the display device by the machine, detects the optical or acoustic signals displayed by the bank note and compares them with the measuring signals expected for authentic bank notes.

Associated bank notes will be recognizable particularly reliably automatically or by humans, without using further aids, when the display state of the display device changes temporally. In the simplest case this can consist in the display being effected only temporarily. This can be done by the display device being supplied with current, in particular by an external energy source, for example by means of a photocell or by an inductive coupling, and lighting up or emitting sound signals only when supplied with energy. Since a permanent sound display would be disturbing in bank notes, the variant is particularly preferred of the display being effected only upon a supply of energy from outside.

As opposed to this ending of the display upon interruption of the external energy supply, it can also be of advantage for the display device to have an interface for the signal drive of the display device, in particular by optical and/or electronic means, which is particularly preferably connected or connectable via a signal line with a control device which is integrated in the value document or at least partly or completely external and changes, or can change, a display state of the display device in a timed way.

In this case the display state can also be changed in a predefined way independently of the supply of energy. The time until a change can be fixed e.g. as random or at one or more certain instants or as happening at defined time intervals. A particularly simple example of this is a flashing display, e.g. a flashing point-shaped LED, which lights up at predefined time intervals. The associated control data will preferably be stored in a memory of the control device.

Further, not only the display state can be changed for example by changing the brightness or volume of the display device, but the displayed information content itself can be changed temporally, too. This can mean e.g. that the audio transmitter plays different display frequencies or frequency sequences or, in the case of a two-dimensional display surface, different display patterns, such as signs or symbols, are displayed. To facilitate the optical or acoustic distinction of bank notes of different nominal value, it can be provided that the display states are different for different nominal values e.g. through different sound frequencies or luminance signals.

According to a further preferred embodiment, the display is used as an information or advertising space where information is shown. In particular, an intended use for the value document can be displayed. In this case the use of the bank note is not completely free, but a certain use, such as purchase in certain shops or of certain goods, is preferred or restricted or excluded. This display of the intended use can have a mandatory effect or act only as a recommendation.

Further, accordingly adjusted testing devices can for example refuse to accept such value documents for payment of goods excluded by the display. Since the information on intended use is displayed in visually visible fashion, it is possible to recognize immediately even without additional aids during circulation of the money whether the bank notes are released for a certain use.

In this connection it is possible for a store e.g. to have its logo shown by writing corresponding data to the electronic memory of the display, and to accept the thus marked bank notes as a discount coupon upon a purchase. For a bank note with a nominal value of ∉ 100, the customer would receive e.g. goods valued at ∉ 110 upon a purchase. If the store does not wish to reissue the coupon bank note, it will then delete the displayed information marking the coupon by e.g. transmitting corresponding control signals to the control device of the bank note.

The display can moreover be used advantageously to display the instantaneous validity of a bank note. It is conceivable, for example, for accordingly authorized banks to write to the memory of the control device integrated into the bank note a code which completely limits the use of the bank note, i.e. makes the bank note invalid temporarily or permanently. This state will be recognized for such bank notes by associated reading devices and the bank notes then be classified as unauthentic. To permit this invalidity to be recognized even without a reading device, however, the validity state is additionally shown on the display. In this case it is already sufficient to provide e.g. an LED in the bank note which is switched on or off for an invalid bank note.

The optical display is preferably made of an electronic paper so as not to impair the flexibility of the bank notes usually made of paper.

Further, the invention is solved by an apparatus for processing sheet-shaped value documents having integrated therein a writable memory, such as an EPROM, EEPROM, and a display device which displays an information content optically and/or acoustically, whereby the apparatus is provided with a writing device for writing data to the memory to permit a display state of the display device to be changed e.g. in the above-mentioned ways by changing a data content of the memory.

It should be emphasized that the data are preferably stored in the memory encrypted and/or secured by a password to make sure that the data controlling the display can only be changed by accordingly authorized writing devices and/or persons.

### BRIEF DESCRIPTION OF THE DRAWINGS

Further embodiments and advantages of the present invention will hereinafter be explained and described in more detail with reference to the enclosed drawings, in which:

FIG. 1 shows schematically a bank note according to a first embodiment, with an optical display in a first display state;

FIG. 2 shows the bank note according to FIG. 1 in a second display state;

FIG. 3 shows schematically a bank note with an optical display according to a second embodiment;

FIG. 4 shows schematically an apparatus for processing bank notes according to a first embodiment;

FIG. 5 shows schematically a bank note with an audio transmitter according to a third embodiment;

FIG. 6 shows schematically a bank note with an audio transmitter according to a fourth embodiment; and

FIG. 7 shows schematically an apparatus for processing bank notes according to a second embodiment.

### DETAILED DESCRIPTION OF THE INVENTION

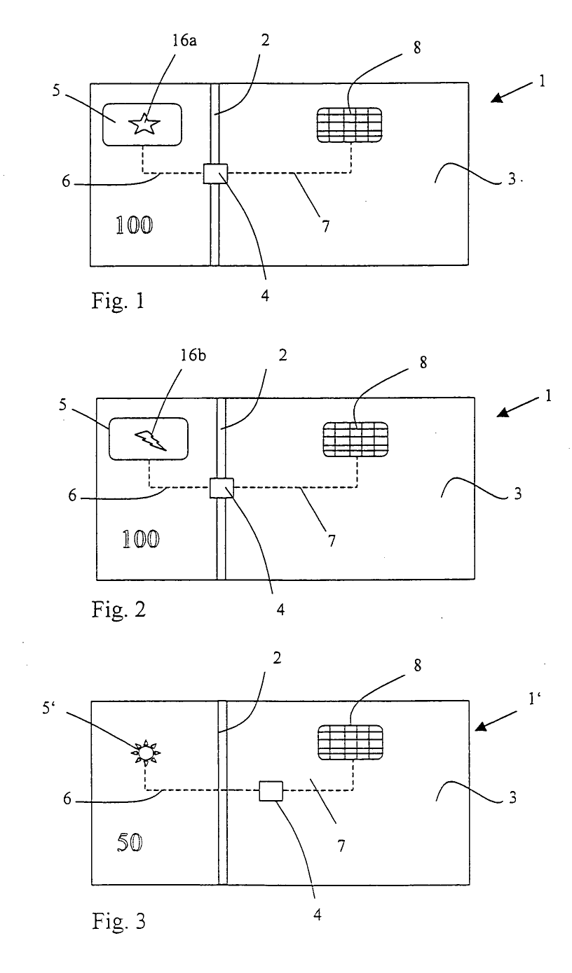

FIG. 1 shows a bank note 1 according to a first embodiment. The bank note 1 has, as one security element among others, a security thread 2 integrated in the bank note paper. Moreover, the bank note paper 1 has incorporated therein an integrated circuit formed as a chip 4, as described e.g. in EP 0 905 657 A1. The metallic security thread 2 acts as an open dipole antenna via which data and/or energy are emitted contactlessly from an external device to the chip and/or emitted from the chip 4. The chip 4 comprises a memory (not shown) for storing data. This can be e.g. a memory chip proper (ROM), a rewritable chip (EPROM, EEPROM) or also a microprocessor chip.

The bank note 1 is characterized in that it comprises an LCD display 5. The LCD display 5 can be incorporated in the bank note paper 3 or applied thereto with per se known thin film technologies. The display 5 is connected to an interface (not shown) of the chip 4 via an electric signal line 6 integrated in the paper 3. Said connection 6 serves to drive the display 5 in a way to be described hereinafter in greater detail. The chip 4 is further connected via a further signal line 7 to a photovoltaic cell 8, referred to for short as “photocell” 8. The photocell 8 serves to supply the chip 4 and the display 5 with energy upon irradiation. In the case shown, the chip 4 is present as a separate unit in a different area of the paper 3 from display 5 or photocell 8. Alternatively, the chip 4 can also be integrated in the display 5 or photocell B itself. The power supply need not necessarily be effected by means of a photocell integrated in the paper 3. Alternatively or additionally, the dipole antenna 2 can also be used for contactless inductive coupling of energy from outside.

As known in the art, the LCD display 5 has a display surface consisting of a matrix of image points each having an assigned pair of electrodes, so that applying an electric voltage to the associated electrodes will alternatively activate the individual pixels to display a given pattern 16a on the display 5, as shown by way of example in FIG. 1. The displayed patterns 16a can be e.g. texts and/or symbols. The use of symbols, such as pictographs, is preferred here due to the small dimensions of the display surfaces in the range of a few centimeters, since it can be difficult to read texts because of the small type sizes that would be required.

The display 5 can be designed here so that a supply of energy is necessary for maintaining an instantaneous display state, so that the pattern 16a is only shown when the display 5 is supplied with current, by illumination of the photocell 8 with light. Alternatively, it is also conceivable that the pattern 16a is displayed permanently and the supply of energy by means of the photocell must only be present when the displayed pattern 16a is to be changed in the course of time, since electric current is needed for transmission of the changed control signals from the chip 4 to the display 5.

Regardless of whether the displayed pattern 16a is displayed only upon illumination of the photocell 8 or permanently, the display 5 can be so designed that either only one, firmly preset pattern 16a is always displayed, or the displayed pattern changes in the course of time. FIG. 2 shows e.g. the display 5 of FIG. 1 in a second operating state in which a changed pattern 16b is displayed.

Since the display 5 does not always display only a firmly preset pattern, but alternating patterns, a security feature is realized that is particularly striking visually and cannot be falsified by usual copying and printing methods.

By way of example the case shall be described that when energy is supplied from outside, e.g. by means of the photocell 8, the display 5 switches between these two display states, i.e. the patterns 16a and 16b, at time intervals preset as constant. The control signals for switching the display 5 are stored in a memory area of the chip 4 which drives the display in timed fashion in accordance with said control signals via the signal line 6. Since in this embodiment it is not crucial to change the switchover characteristics of the display 5 in controlled fashion from outside in the course of time, the associated memory area will preferably be designed as a non-rewritable memory to which data about the desired and unchangeable display properties are inputted once only before the bank notes 1 are issued. Since the memory area is only writable once, an unwanted change or manipulation of the display states can consequently be prevented.

If, as described in the previous case, the display 5 is used as an authenticity feature that is operated by switching between two or more states, this embodiment can be realized particularly simply by a point-shaped display, such as a flashing LED 5′, as is integrated in the bank note 1′ according to the second embodiment of FIG. 3. In this case a drive of the chip 4 from outside can also be dispensed with. For this reason it is further not absolutely necessary to provide an antenna for driving the chip 4, unlike the embodiment of FIGS. 1 and 2. The chip 4 is therefore not integrated in the optional security thread 2 of the bank note 1′, i.e. the security thread 2 has been incorporated into the bank note paper 3 without acting as a dipole antenna and being connected to the chip 4. This leads to a simplified structure of the bank note.

As mentioned, it will only be expedient to provide a chip antenna 2 when the display state of the display 5, 5′ is to be changed in controlled fashion from outside by the memory content of the chip 4 being changed by an external writing apparatus. In this case, associated control data are preferably (transmitted) [added by the Translator] contactlessly via an inductive coupling of an antenna of the writing apparatus with the antenna of the bank note, such as the dipole antenna 2 of the bank note 1.

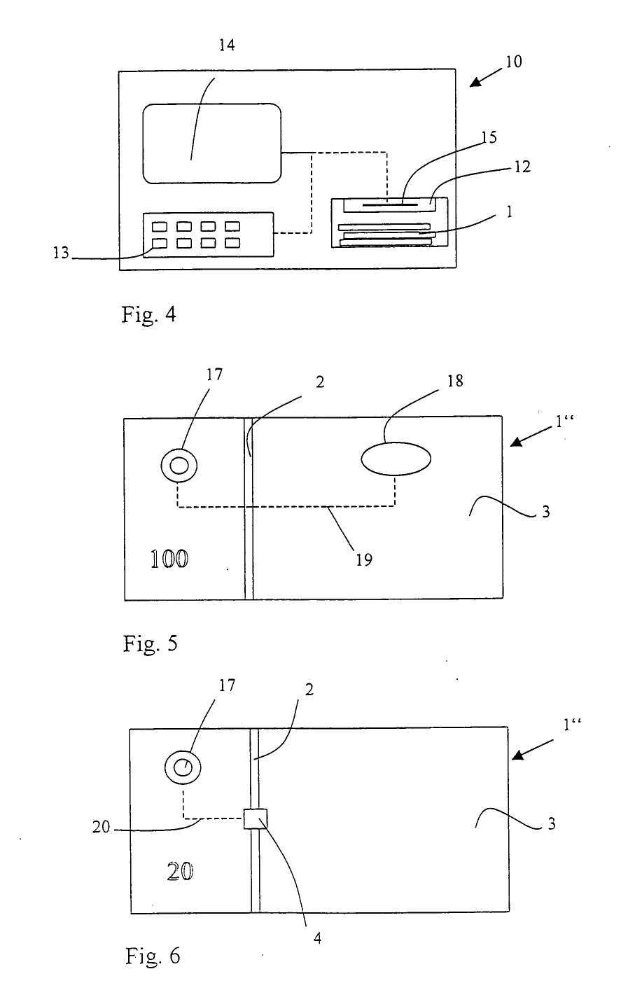

An example of such a writing apparatus 10 is shown in FIG. 4. The apparatus 10 comprises by way of example an input pocket 11 for bank notes 1, a writing device 12 with a transmitting antenna 15 for contactless, inductive transmission of data received by the antenna of the chip 4 of the bank notes 1 inserted into the pocket 11, a keyboard 13 as an operator unit 13 for controlling the transmission process, and an associated monitor 14 for displaying information on the data to be inputted to the chip, among other things. Via the keyboard an operator enters in what way the display state of the display 5 is to be changed, e.g. how the switchover characteristics are to be changed upon alternation between different display states. Associated control data are then transmitted via the transmitting antenna 15 contactlessly by means of an inductive interaction to the antenna 2 of the chip 4. Due to the signals received by the antenna 2, a data content of the memory of the chip 4 is subsequently changed, which leads to a change in the instantaneous display state or to changes in the given course of the assumption of different display states.

There are numerous application cases for bank notes 1, 1′ in which a display state of the display 5, 5′ can be changed by writing data to the memory of the chip 4 for example by means of the apparatus 10 according to FIG. 4.

Thus the display can be used to provide information on the validity of the bank note. If the display of the bank note lights up for example when supplied with energy from outside, this should mean that the bank note is instantaneously valid. If the display does not light up, this means the bank note is invalid. The allocation can also be the other way round. In this case the change of display state consequently consists solely in an activation or deactivation of the display. Since the displayed information is therefore selected from only two states, the display chosen can preferably be a binary display which can only assume two different states. For this purpose a modified variant of the bank note 1′ of FIG. 3 can be used, for example, in which the point-shaped LED 5′ can be selectively switched on and off by coupling in control signals by means of a receive antenna of the chip 4, which is then required.

This application is also expedient when bank notes are to be temporarily deactivated, i.e. made invalid. For example, if bank notes are deactivated before being transported from one place to another, e.g. from the issuing central bank to a commercial bank, bank notes stolen in a raid on such a transport can be easily identified. It is further also conceivable to activate bank notes only immediately before they are issued to a customer in a bank or by a cash dispenser. Moreover, in the case of ransom money, for example, data can be written to the memories of the bank note chips so as to lead to a time-delayed blocking, i.e. deactivation, of the display 5′, so that the money is marked and can be recognized as invalid only with a delay after it is handed over to a blackmailer.

It is particularly important among other things in the above-mentioned cases that the display of the instantaneous validity of the bank notes can only be changed by accordingly authorized persons. This can be obtained if the data are stored in the chip 4 encrypted and/or secured by a password, and the associated chip data can only be changed with knowledge of the password or encryption algorithm or only with apparatuses 10 specifically adjusted to write to the associated bank note chips. For this purpose the memory can comprise e.g. an authentication system containing data about different access authorizations for reading and/or changing the data content of the memory. Further, upon changes of the data content of the memory that relate to changes of the display state of the display device, identification data can be stored in the memory which state by whom and/or with what apparatus and/or when and/or where the associated data were inputted to the memory, in order to permit the changes made to be clearly traced and checked later by readout of the memory content. In the case of activation or deactivation of bank notes, the writing apparatuses will be present e.g. exclusively at the banks in charge.

A further application for bank notes 1, 1′ with a display can consist in using the display as an information or advertising space where information is shown. Thus, the information content shown by the display can relate to information on an intended use of the particular bank note. In this case the use of the bank note is not completely free, but a certain use, such as purchase in certain shops or of certain goods, is preferred or restricted or excluded. This display of the intended use can have a mandatory effect or act only as a recommendation.

In this connection it is possible that a store has its logo shown in the display 5, 5′ by writing corresponding data to the memory of the chip 4, and accepts the thus marked bank notes 1 as discount coupons. For a bank note 1 with a nominal value of ∉ 100, the customer would receive e.g. goods valued at ∉ 110 upon a purchase. Further, it can also be displayed that the bank notes can only be exchanged for certain goods or groups of goods, so that bank notes 1 issued e.g. by parents to their children as pocket-money will show symbols on the display 5 to indicate that no goods like alcohol or cigarettes may be bought with such money. It can further be provided that accordingly adjusted testing devices at a department store cash register e.g. read the memory content of the bank note chips 4 that relates to the display 5 and refuse to accept such bank notes for payment of goods excluded by the display 5.

If goods valued lower than the nominal value of the bank notes 1 are bought at a department store, for example, the indication of use can preferably be taken over for the change given to the customer. The bank note 1 used for payment is consequently recognized automatically when paid into the cash register, and the change marked, by means of a contactless coupling with the chip of the bank notes used for change, according to the displayed intended use of the bank note used for payment, via a writing device which is integrated in the cash register or external.

It should be noted that a display according to the invention can also be integrated into coins, so that in the above-mentioned case e.g. the indications of intended use can also be taken over for the coins used as change.

Besides the above-described embodiments of bank notes with an optical display, an inventive value document also can comprise an integrated acoustic display device. FIG. 5 shows an embodiment of such a bank note 1″ with an electroacoustic audio transmitter 17 integrated in the bank note paper 3. Moreover, the bank note paper 3 has a piezoelectric transducer 18 incorporated firmly therein. The transducer 18 serves to produce electric energy by compression of the transducer 18, said energy being transmitted via a signal line 19 to the audio transmitter 17 and exciting it to emit acoustic, humanly audible sound waves.

Compression of the transducer 18 can be effected either by compressing with the fingers or e.g. by knocking the bank note 1″ on a firm base such as a table.

An alternative embodiment of such a bank note 1″ with an audio transmitter is shown in FIG. 6. It differs from that according to FIG. 5 in that no piezoelectric transducer is present as an energy source, but the energy for operating the audio transmitter 17 is transmitted contactlessly through an external alternating field to a security thread 2 acting as an open dipole antenna. The security thread 2 is coupled in analogy to the bank note 1 according to FIGS. 1 and 2 with a chip 4 via which the receiving energy is supplied to the audio transmitter 17 via the signal line 20.

Further, the supply of energy could also be effected by means of a photocell integrated in the paper as is the case e.g. in the bank note according to FIGS. 1 and 2. To prevent the bank note from continually emitting acoustic signals upon illumination in this case, activation of the audio transmitter 17 can be triggered e.g. by means of a piezoelectric transducer 18 integrated in the paper 3 according to the example of FIG. 5. After compression of the transducer 18 the energy provided by means of the photocell is thus supplied to the audio transmitter 17 so that the latter then emits acoustic signals for a limited time period corresponding for example to the duration of compression of the transducer 18.

It should be emphasized that the above-mentioned embodiments relating to the temporal changes of the display state of the display 5, 5′ can also be used analogously for a bank note 1″ with an audio transmitter 17.

Thus, the display state can be changed not only by changing for example the brightness of the display, but accordingly the volume of an audio transmitter if one is present. Further, the temporal change of the displayed information content can mean e.g. that the audio transmitter plays different display frequencies or frequency sequences.

An embodiment which is also preferred for the optical display 5, 5′, but particularly advantageous for the variant with an audio transmitter 17, provides that the optical or acoustic distinction of bank notes 1, 1′, 1″ of different nominal value is facilitated by the display states being different for different nominal values. This can be obtained by the emission of different sequences of words or tones, e.g. also in analogy to the Morse alphabet by combinations of short beep signals or also by different sound frequencies or optically displayed patterns 16a, 16b for each nominal value. Specifically, the emission of acoustic signals has the advantage here that such bank notes can also be distinguished reliably and simply by blind persons.

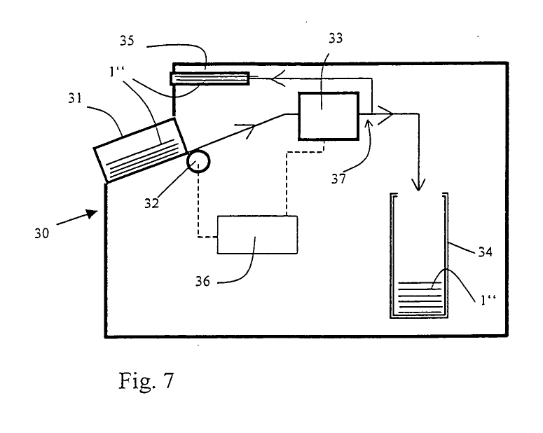

FIG. 7 shows a second embodiment of an inventive bank note processing apparatus 30. The apparatus 30 can be a bank note deposit apparatus 30 for processing bank notes, such as the bank notes 1-1″ according to FIGS. 1, 2, 3, 5 or 6. By way of example it is shown that bank notes 1″ are inputted into an input pocket 31, drawn in singly by means of a singling unit 32 and checked by a sensor device 33. Then, activated by a control unit 36 connected to, among other things, the sensor device 33 and a following diverter 37, the accepted bank notes 1″ are diverted to a cassette 34 and deposited, or the non-accepted bank notes 1″ outputted to an output pocket 35 for the depositor.

The sensor device 33 is characterized in that it can measure the optical or acoustic signals emitted by the inventive display device of the bank notes. These measuring signals are then compared with predefined reference values corresponding to authentic bank notes to ascertain whether the just checked bank note is authentic. Authenticity will preferably be confirmed only if the check of further machine-readable security features which bank notes normally have is also positive.

It can be provided that the bank notes 1-1″ are excited to display acoustic and/or optical signals by an activation unit associated with the sensor device 33, e.g. by optical, mechanical, electric and/or magnetic coupling. In the case of acoustic display, for example, this can be effected by irradiating a photocell, pressing a pressure-sensitive element 18 and/or coupling by means of a dipole antenna 2 according to the description for FIGS. 5 and 6.

Further, the sensor device 33 can in the case of acoustic display devices comprise a sonic detector which detects the acoustic signals emitted by the bank note 1″. Preferably the sonic detector, with the associated transport system for transporting past the bank note 1″ to be measured, is mounted in soundproof fashion in this area e.g. in a housing in order to reduce background noises through other machine components that would disturb measurement.

To determine authenticity, the control unit 36 will, in a simple embodiment, check only the presence or absence of acoustic signals of a predefined minimum strength. Preferably the check will, on the same occasion or alternatively, detect only one or more certain frequencies and/or frequency domains or extract them from the measuring values by means of a frequency analysis, optionally with consideration of background noises normally occurring. Additionally or alternatively, the time behavior of the measured signals can also be evaluated. In the case for example that the display device of the bank note 1-1″ emits temporally pulsed signals, it is determined whether the time interval of the single signals is correct, at least when the pulse spacings are in ranges that permit checking at a desired speed. Since high throughput rates are usually crucial in bank note processing apparatuses, it is of advantage that the bank notes 1-1″ are excited by an associated activation unit to emit pulsed signals with a high-frequency signal string, i.e. pulses with short time intervals. The signal string frequency will preferably be in a range of 10 Hz or more.

If the signals of the display devices are e.g. denomination-specific, the reference values with which the measuring signals are compared will likewise be accordingly predefined in denomination-specific fashion. Suitable reference values will preferably be selected by the sensor device 36 previously inferring the potential denomination of the bank note to be checked, on the basis of other measuring values. Alternatively, the measuring values for the signals of the display device can serve to obtain an indication of the possible denomination of the bank note to be checked. For the final establishment of the authenticity of the bank notes, it is preferably determined here whether the checks from other security features actually all indicate the same denomination too.

The above-mentioned embodiments also apply in principle to the detection of signals from optical display devices. In a simple case, e.g. merely a photosensitive element of any kind can be present as the sensor device 33, said element checking e.g. for variable signals for flashing displays 5′ as in FIG. 3 whether the flashing signals are emitted by the bank note 1′ with suitable signal spacing and/or with suitable frequencies. Optionally the sensor device 33 can also have an area sensor, such as a CCD array, or a line sensor read in clocked fashion in order to record a two-dimensional image of the display device and compare it with the expected display of an authentic bank note.

The above-mentioned embodiments can of course also be used in other bank note processing machines, such as sorting and/or counting apparatuses, wherein the authenticity of sheet-shaped value documents is to be determined.

The present invention therefore provides an authenticity feature which can be reliably verified by humans and/or by machine and cannot be deceptively imitated by copying technology.

1. A sheet-shaped value document, such as a bank note (1, 1′, 1″), characterized by at least one of an electro-optical and acoustic display device (5, 5′, 17) integrated in the value document and capable of displaying an information content optically or acoustically.

2. A value document according to claim 1, characterized in that the display device comprises at least one of
a) a self-luminous optical display radiating in at least one of visible, infrared and UV spectral range,
b) a non-self-luminous optical display,
c) a display made of electronic paper,
d) an LCD (5, 5′),
e) an LED (17),
f) an electroacoustic audio transmitter (17),
g) a reciprocal piezoelectric audio transmitter, and
h) a magnetostrictive audio transmitter.

3. A value document according to claim 1, characterized in that the display device (5, 5′, 17) comprises an interface for the signal drive of the display device.

4. A value document according to claim 3, characterized in that the interface is connected or connectable via a signal line (6, 20) with a control device (4, 10) which is integrated in the value document or at least partly or completely external and can change a display state of the display device.

5. A value document according to claim 4, characterized in that the control device (4, 10) can drive the display device to change the display state by the information content being displayed only temporarily.

6. A value document according to claim 3, characterized in that the control device (4, 10) can drive the display device to change the display state by the control device temporally changing the displayed information content.

7. A value document according to claim 4, characterized in that the display device (5, 5′) can display several information contents at the same time, the control device (4, 10) can switch the display device (5, 5′, 17) between more than two different display states, or a combination thereof.

8. A value document according to claim 4, characterized in that the display device (5, 5′, 17) assumes one of two or more different display states in a predefined temporal alternation.

9. A value document according to claim 4, characterized in that the control device (4, 10) comprises an externally writable data memory (4) to permit the display state of the display device to be changed by changing a data content of the memory.

10. A value document according to claim 9, characterized in that at least part of the data content of the memory (4) is stored encrypted, secured by a password, or a combination thereof.

11. A value document according to claim 9, characterized in that the memory (4) comprises an authentication system containing data about different access authorizations for reading, changing at least part of the data content of the memory, or a combination thereof.

12. A value document according to claim 9, characterized in that upon changes of the data content of the memory (4) that relate to changes of the display state of the display device (5, 5′, 17), identification data are stored in the memory which state by at least one of whom and with what apparatus (10) and when and where the associated data were inputted to the memory (4).

13. A value document according to claim 1, characterized in that the optical display device (5, 5′) a) displays at least one of text and symbols as the information content, b) the acoustic display device (17) emits sound signals which are specific to a nominal value of the value document, or a combination of a) and b).

14. A value document according to claim 1, characterized in that the display device (5′) displays information on the instantaneous validity of the value document as the information content.

15. A value document according to claim 1, characterized in that the display device (5) displays an intended use for the value document as the information content.

16. A method of enhancing security of a sheet-shaped value document, comprising integrating into said document at least one of an electro-optical and an acoustic display device (5, 5′, 17) capable of displaying an information content optically or acoustically, for displaying information on the instantaneous validity of the value document, an intended use for the value document, or a combination thereof.

17. An apparatus (10) for processing sheet-shaped value documents (1, 1′, 1″) with an integrated display device (5, 5′, 17) which displays an information content optically, acoustically, or a combination thereof, which comprises at least one of a writing device (12, 15) for writing data to a data memory (4) of the value document to permit a display state of the display device to be changed by changing a data content of the memory, and a sensor device (33) which, for determining the authenticity of the value documents (1, 1′, 1″), measures the information contents thereof displayed optically or acoustically by the display device (12, 15) and compares the thus measured signals with predefined reference values corresponding to authentic value documents (1, 1′, 1″).

18. An apparatus according to claim 17, characterized in that the writing device (12, 15) is for writing data to a memory of the value document to permit a) the display device to be switched on, off, or a combination thereof, b) the displayed information content to be changed by changing at least part of a data content of the memory, or a combination of a) and b).

19. An apparatus according to claim 17, characterized in that the sensor device (33) comprises at least one of a sonic detector and an optical detector.

20. An apparatus according to claim 17, characterized in that the sensor device (33) evaluates the measured signals according to at least one of signal strength, signal frequency and temporal signal sequence.

21. An apparatus according to claim 17, characterized by an activation unit assigned to the sensor device (33), for exciting the bank notes (1, 1′, 1″) to display at least one of acoustic and optical signals.

22. The value document of claim 3 wherein said interface is optical or electronic.

23. The value document of claim 5 wherein said control device can switch the display device on and off.

24. The value document of claim 13 wherein said symbols comprise pictographs.

25. The value document of claim 16 wherein said document is a banknote.

26. The value document of claim 21 wherein said activation unit excites the bank notes by at least one of optical, mechanical, electric and magnetic coupling.
